(19) United States
(12) Patent Application Publication
(10) Pub. No.: US 2021/0108020 A1
(43) Pub. Date: Apr. 15, 2021

(54) POLYURETHANE PREPOLYMER COMPOSITION, AND POLYURETHANE ELASTOMER AND METHOD FOR PREPARING THE SAME

(71) Applicant: LIDYE CHEMICAL CO., LTD., Taoyuan City (TW)

(72) Inventors: Wen-Hsin LIN, New Taipei City (TW); Fu-Cheng CHUANG, Taoyuan City (TW); Cheng Hung HSIEH, Kaohsiung City (TW); Chin-Hsien KAO, New Taipei City (TW); Jeng-Chyuan CHEN, Taoyuan City (TW)

(73) Assignee: LIDYE CHEMICAL CO., LTD., TAOYUAN CITY (TW)

(21) Appl. No.: 16/878,820

(22) Filed: May 20, 2020

(30) Foreign Application Priority Data
Oct. 9, 2019 (TW) 108136577

(51) Int. Cl. C08G 18/12; C08G 18/32; C08G 18/76; C08G 18/73; C08G 18/42; C08G 18/44; C08G 18/48

(52) U.S. Cl. CPC C08G 18/12; C08G 18/3206; C08G 18/7642; C08G 18/7621; C08G 18/485; C08G 18/735; C08G 18/4277; C08G 18/44; C08G 18/765

(57) ABSTRACT

A polyurethane prepolymer composition is provided. The polyurethane prepolymer composition includes a first prepolymer, a second prepolymer and a third prepolymer. The first prepolymer includes a polyol and diisocyanates. The two ends of the polyol are connected with the diisocyanates. The second prepolymer includes a diisocyanate monomer. The third prepolymer includes a first diisocyanate, polyols and second diisocyanates. The two ends of the first diisocyanate are connected with the polyols. The other ends of the polyols are connected with the second diisocyanates. A polyurethane elastomer and a preparation method thereof are also provided.

### CROSS REFERENCE TO RELATED APPLICATIONS

This Application claims priority of Taiwan Patent Application No. 108136577, filed on Oct. 9, 2019, the entirety of which is incorporated by reference herein.

### BACKGROUND OF THE INVENTION

### Field of the Invention

The invention relates to a polyurethane (PU) elastomer, and more particularly to a polyurethane elastomer having the characteristics of high rigidity and high elastic recovery.

### Description of the Related Art

The main structure of tire is divided into three parts, an outer rubber tread, a spoke (Web) layer for structural support, and an inner-layered structure. The spoke (web) layer is a non-inflatable layer, which applies reactive polyurethane (PU) resin material for casting. At present, many manufacturers are focusing on the developments of polyurethane resins for producing non-inflatable tires.

An ideal PU elastomer includes soft and hard segments well-arranged by phase separation, which endows the elastomer with elasticity. The soft segments are of equal length and can be easily deformed, while the hard segments are compacted firmly, forming well-packed structure. Micro-phase separation of PU elastomer leads to well-defined hard and the soft domains, resulting in its high elasticity, high crystallinity and good stiffness (rigidity). However, it is difficult to achieve perfect phase-separation in practice.

Generally, perfect elastomers are hypothetical, which means the hard and soft segments/domains are never fully well-arranged or separated. The imperfect hard domains lead to weaken rigidity, and soft domain to deteriorate rebound resilience. Moreover, the ratio between hard and soft segments also greatly affects the mechanical property of PU elastomer. For instance, excessive soft segment gives higher rebound resilience, but the rigidity may be degraded. On the contrary, insufficient or poorly arranged soft segments/domains may also lead to inferior rebound resilience.

Therefore, development of PU elastomer with both high rigidity and high elastic recovery could be challenging.

### BRIEF SUMMARY OF THE INVENTION

In accordance with one embodiment of the invention, a polyurethane prepolymer composition is provided. The polyurethane prepolymer composition includes a first prepolymer, a second prepolymer and a third prepolymer. The first prepolymer includes a polyol and diisocyanates. The two ends of the polyol are connected with the diisocyanates. The second prepolymer includes a diisocyanate monomer. The third prepolymer includes a first diisocyanate, polyols and second diisocyanates. The two ends of the first diisocyanate are connected with the polyols. The other ends of the polyols are connected with the second diisocyanates.

In some embodiments, the polyol includes polytetramethylene ether glycol (PTMEG), polypropylene glycol (PPG), polyethylene glycol (PEG), polycarbonate diol (PCDL), polycaprolactone diol (PCLDL) or ethylene oxide-propylene oxide (EO-PO) copolymer diol.

In some embodiments, the diisocyanate of the first prepolymer, the diisocyanate monomer of the second prepolymer, and the first diisocyanate and the second diisocyanate of the third prepolymer include methylenediphenyl diisocyanate (MDI), hydrogenated 1,4-xylylene diisocyanate (1,4-H6XDI), xylylene diisocyanate (XDI), 1,4-phenylene diisocyanate (PPDI), tolylene diisocyanate (TDI), hexamethylene diisocyanate (HDI), isophorone diisocyanate (IPDI), 4,4′-methylene dicyclohexyl diisocyanate (H12MDI), trimethyl hexamethylene diisocyanate (TMDI), 1,5-naphthalene diisocyanate (NDI) or 3′-dimethylbiphenyl-4,4′-diyl diisocyanate (TODI).

In some embodiments, the ratio of the third prepolymer in the polyurethane prepolymer composition is in a range from 0% to 65%. In some embodiments, the ratio of the third prepolymer in the polyurethane prepolymer composition is in a range from 10% to 20%.

In accordance with one embodiment of the invention, a polyurethane elastomer is provided. The polyurethane elastomer includes a first polymer and a second polymer. The first polymer includes a plurality of soft segments and a plurality of hard segments which are alternately arranged with each other. The soft segment of the first polymer includes the polyol of the disclosed first prepolymer. The hard segment of the first polymer includes a chain extender, the diisocyanate of the first prepolymer and the diisocyanate monomer of the second prepolymer. The soft segment and the hard segment of the first polymer are connected by a urethane bond. The second polymer is arranged adjacent to the first polymer. The second polymer includes a plurality of soft segments and a plurality of hard segments which are alternately arranged with each other. The soft segment of the second polymer includes the first diisocyanate and the polyols of the disclosed third prepolymer. The hard segment of the second polymer includes a chain extender, the second diisocyanate of the third prepolymer and the diisocyanate monomer of the second prepolymer. The soft segment and the hard segment of the second polymer are connected by a urethane bond. There is a hydrogen bond formed between the soft segment of the first polymer and the soft segment of the second polymer.

In some embodiments, the chain extender includes ethylene alcohol (EG), propylene alcohol (PG), 1.4-butylene alcohol (1.4-BDO), 1.3-butylene alcohol (1.3-BDO), 1,6-hexanediol (1,6-HD), diethylene glycol (DEG), 3-methyl-2,5-pentadiol (MPD) or diethylene glycol (DPG).

In some embodiments, the ratio of the second polymer in the polyurethane elastomer is in a range from 0% to 60%. In some embodiments, the ratio of the second polymer in the polyurethane elastomer is in a range from 10% to 20%.

In accordance with one embodiment of the invention, a method for preparing a polyurethane elastomer is provided. The preparation method includes the following steps. First, polyols and a diisocyanate are mixed to form the first polyol. Both ends of the diisocyanate are connected with the polyols. Next, a polyol, diisocyanates and the first polyol are mixed to form polyurethane prepolymer. The polyurethane prepolymer composition includes a first prepolymer, a second prepolymer and a third prepolymer. The first prepolymer includes the polyol and the diisocyanates connected to the two ends of the polyol. The second prepolymer includes the diisocyanate. The third prepolymer includes the first polyol and the diisocyanates connected to the two ends of the first polyol. Next, a chain extender is added to form a polyurethane elastomer. The polyurethane elastomer includes a first polymer and a second polymer which is arranged adjacent to the first polymer. The first polymer includes a plurality of soft segments and a plurality of hard segments which are alternately arranged with each other. The soft segment of the first polymer includes the polyol of the first prepolymer. The hard segment of the first polymer includes the chain extender, the diisocyanate of the first prepolymer and the diisocyanate of the second prepolymer. The soft segment and the hard segment of the first polymer are connected by a urethane bond. The second polymer includes a plurality of soft segments and a plurality of hard segments which are alternately arranged with each other. The soft segment of the second polymer includes the first polyol of the third prepolymer. The hard segment of the second polymer includes the chain extender, the diisocyanate of the third prepolymer and the diisocyanate of the second prepolymer. The soft segment and the hard segment of the second polymer are connected by a urethane bond. There is a hydrogen bond formed between the soft segment of the first polymer and the soft segment of the second polymer.

In the present invention, in order to achieve high rigidity and high elastic recovery simultaneously, the structure of the soft segment is modified to generate a sub-crosslinking structure within the soft segments. The cross-linking strengthens the structure and alignment of the soft domain. Modifications, such as polyfunctionalization, chemical cross-linking, and physical cross-linking (e.g. Van der Waals force), are commonly applied to maintain the arrangement of the soft segments. The present invention applies special molecular modifications in the soft segments to reinforce hydrogen bonds within the soft domains. By cross-linking the soft segments, the PU elastomer shows improved hardness and rigidity, while it still holds the considerable rebound resilience.

A detailed description is given in the following embodiments with reference to the accompanying drawings.

### BRIEF DESCRIPTION OF THE DRAWINGS

The present invention can be more fully understood by reading the subsequent detailed description and examples with references made to the accompanying drawings, wherein:

FIG. 1 shows a hydrogen bonding between polymer soft segments in a polyurethane elastomer in accordance with one embodiment of the invention.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

In accordance with one embodiment of the invention, a polyurethane prepolymer composition is provided. The polyurethane prepolymer composition includes a first prepolymer, a second prepolymer and a third prepolymer. The first prepolymer includes a polyol and diisocyanates. The two ends of the polyol are connected with the diisocyanates. The second prepolymer includes a diisocyanate monomer. The third prepolymer includes a first diisocyanate, polyols and second diisocyanates. The two ends of the first diisocyanate are connected with the polyols. The other ends of the polyols are connected with the second diisocyanates.

In some embodiments, the polyol may include polytetramethylene ether glycol (PTMEG), polypropylene glycol (PPG), polyethylene glycol (PEG), polycarbonate diol (PCDL), polycaprolactone diol (PCLDL) or ethylene oxide-propylene oxide (EO-PO) copolymer diol.

In some embodiments, the diisocyanate of the first prepolymer, the diisocyanate monomer of the second prepolymer, and the first diisocyanate and the second diisocyanate of the third prepolymer may include methylenediphenyl diisocyanate (MDI), hydrogenated 1,4-xylylene diisocyanate (1,4-H6XDI), xylylene diisocyanate (XDI), 1,4-phenylene diisocyanate (PPDI), tolylene diisocyanate (TDI), hexamethylene diisocyanate (HDI), isophorone diisocyanate (IPDI), 4,4′-methylene dicyclohexyl diisocyanate (H12MDI), trimethyl hexamethylene diisocyanate (TMDI), 1,5-naphthalene diisocyanate (NDI) or 3′-dimethylbiphenyl-4,4′-diyl diisocyanate (TODI).

In some embodiments, the ratio of the third prepolymer in the polyurethane prepolymer composition is in a range from about 0% to about 65%. In some embodiments, the ratio of the third prepolymer in the polyurethane prepolymer composition is in a range from about 10% to about 20%.

In accordance with one embodiment of the invention, a polyurethane elastomer is provided. The polyurethane elastomer includes a first polymer and a second polymer. The first polymer includes a plurality of soft segments and a plurality of hard segments which are alternately arranged with each other. The soft segment of the first polymer includes the polyol of the disclosed first prepolymer. The hard segment of the first polymer includes a chain extender, the diisocyanate of the first prepolymer and the diisocyanate monomer of the second prepolymer. The soft segment and the hard segment of the first polymer are connected by a urethane bond. The second polymer is arranged adjacent to the first polymer. The second polymer includes a plurality of soft segments and a plurality of hard segments which are alternately arranged with each other. The soft segment of the second polymer includes the first diisocyanate and the polyols of the disclosed third prepolymer. The hard segment of the second polymer includes a chain extender, the second diisocyanate of the third prepolymer and the diisocyanate monomer of the second prepolymer. The soft segment and the hard segment of the second polymer are connected by a urethane bond. There is a hydrogen bond formed between the soft segment of the first polymer and the soft segment of the second polymer.

In some embodiments, the chain extender may include ethylene alcohol (EG), propylene alcohol (PG), 1.4-butylene alcohol (1.4-BDO), 1.3-butylene alcohol (1.3-BDO), 1,6-hexanediol (1,6-HD), diethylene glycol (DEG), 3-methyl-2,5-pentadiol (MPD) or diethylene glycol (DPG).

In some embodiments, the ratio of the second polymer in the polyurethane (PU) elastomer is in a range from about 0% to about 60%. In some embodiments, the ratio of the second polymer in the polyurethane (PU) elastomer is in a range from about 10% to about 20%.

In accordance with one embodiment of the invention, a method for preparing a polyurethane elastomer is provided. The preparation method includes the following steps. First, polyols and a diisocyanate are mixed to form a first polyol. The two ends of the diisocyanate are connected with the polyols. Next, a polyol, diisocyanates and the first polyol are mixed to form a polyurethane prepolymer composition. The polyurethane prepolymer composition includes a first prepolymer, a second prepolymer and a third prepolymer. The first prepolymer includes the polyol and the diisocyanates connected to the two ends of the polyol. The second prepolymer includes the diisocyanate. The third prepolymer includes the first polyol and the diisocyanates connected to the two ends of the first polyol. Next, a chain extender is added to form a polyurethane elastomer. The polyurethane elastomer includes a first polymer and a second polymer which is arranged adjacent to the first polymer. The first polymer includes a plurality of soft segments and a plurality of hard segments which are alternately arranged with each other. The soft segment of the first polymer includes the polyol of the first prepolymer. The hard segment of the first polymer includes the chain extender, the diisocyanate of the first prepolymer and the diisocyanate of the second prepolymer. The soft segment and the hard segment of the first polymer are connected by a urethane bond. The second polymer includes a plurality of soft segments and a plurality of hard segments which are alternately arranged with each other. The soft segment of the second polymer includes the first polyol of the third prepolymer. The hard segment of the second polymer includes the chain extender, the diisocyanate of the third prepolymer and the diisocyanate of the second prepolymer. The soft segment and the hard segment of the second polymer are connected by a urethane bond. There is a hydrogen bond formed between the soft segment of the first polymer and the soft segment of the second polymer.

### EXAMPLES/COMPARATIVE EXAMPLES

### Example 1

Preparation of Polyol A

First, 1,000 grams of polytetramethylene ether glycol (PTMEG) (OHV=109.34, Mw/Mn=1.3-1.5) was added to a reaction tank and heated to 85° C. Next, 121.8 grams of methylenediphenyl diisocyanate (MDI) was added to react until no diisocyanate remained. So far, polyol A (including the methylenediphenyl diisocyanate (MDI) and the polytetramethylene ether glycol (PTMEG) connected to the two ends of the methylenediphenyl diisocyanate (MDI)) was prepared.

### Example 2

Preparation of Polyol B

First, 1,000 grams of polytetramethylene ether glycol (PTMEG) (OHV=109.34, Mw/Mn=1.3-1.5) was added to a reaction tank and heated to 85° C. Next, 94.5 grams of hydrogenated 1,4-xylylene diisocyanate (1,4-H6XDI) was added to react until no diisocyanate remained. So far, polyol B (including the hydrogenated 1,4-xylylene diisocyanate (1,4-H6XDI) and the polytetramethylene ether glycol (PTMEG) connected to the two ends of the hydrogenated 1,4-xylylene diisocyanate (1,4-H6XDI)) was prepared.

### Example 3

Preparation of Polyol C

First, 1,000 grams of polytetramethylene ether glycol (PTMEG) (OHV=109.34, Mw/Mn=1.3-1.5) was added to a reaction tank and heated to 85° C. Next, 78.03 grams of 1,4-phenylene diisocyanate (PPDI) was added to react until no diisocyanate remained. So far, polyol C (including the 1,4-phenylene diisocyanate (PPDI) and the polytetramethylene ether glycol (PTMEG) connected to the two ends of the 1,4-phenylene diisocyanate (PPDI)) was prepared.

### Example 4

Preparation of Prepolymer A

Under a nitrogen environment, 269 grams of methylenediphenyl diisocyanate (MDI) was added to a reaction tank and heated to 50° C. with stirring for 30 minutes. Next, 363.6 grams of polytetramethylene ether glycol (PTMEG) (OHV=56, Mw/Mn=2.0-2.3), 122.72 grams of polyol A, and 36.36 grams of polycaprolactone diol (PCLDL) (OHV=56, CAPA7201A/Perstorp) were added in order and reacted at 60° C. until NCO=8.7%. So far, prepolymer A (including the prepolymer of the polytetramethylene ether glycol (PTMEG) and the methylenediphenyl diisocyanate (MDI) connected to the two ends of the polytetramethylene ether glycol (PTMEG), the prepolymer of the polycaprolactone diol (PCLDL) and the methylenediphenyl diisocyanate (MDI) connected to the two ends of the polycaprolactone diol (PCLDL), the methylenediphenyl diisocyanate (MDI) monomer and the prepolymer of the polyol A and the methylenediphenyl diisocyanate (MDI) connected to the two ends of the polyol A) was prepared.

### Example 5

Preparation of Prepolymer B

Under a nitrogen environment, 269 grams of methylenediphenyl diisocyanate (MDI) was added to a reaction tank and heated to 50° C. with stirring for 30 minutes. Next, 363.6 grams of polytetramethylene ether glycol (PTMEG) (OHV=56, Mw/Mn=2.0-2.3), 122.72 grams of polyol B, and 36.36 grams of polycaprolactone diol (PCLDL) (OHV=56, CAPA7201A/Perstorp) were added in order and reacted at 60° C. until NCO=8.71%. So far, prepolymer B (including the prepolymer of the polytetramethylene ether glycol (PTMEG) and the methylenediphenyl diisocyanate (MDI) connected to the two ends of the polytetramethylene ether glycol (PTMEG), the prepolymer of the polycaprolactone diol (PCLDL) and the methylenediphenyl diisocyanate (MDI) connected to the two ends of the polycaprolactone diol (PCLDL), the methylenediphenyl diisocyanate (MDI) monomer and the prepolymer of the polyol B and the methylenediphenyl diisocyanate (MDI) connected to the two ends of the polyol B) was prepared.

### Example 6

Preparation of Prepolymer C

Under a nitrogen environment, 270 grams of methylenediphenyl diisocyanate (MDI) was added to a reaction tank and heated to 50° C. with stirring for 30 minutes. Next, 363.6 grams of polytetramethylene ether glycol (PTMEG) (OHV=56, Mw/Mn=2.0-2.3), 123 grams of polyol C, and 36.36 grams of polycaprolactone diol (PCLDL) (OHV=56, CAPA7201A/Perstorp) were added in order and reacted at 60° C. until NCO=8.7%. So far, prepolymer C (including the prepolymer of the polytetramethylene ether glycol (PTMEG) and the methylenediphenyl diisocyanate (MDI) connected to the two ends of the polytetramethylene ether glycol (PTMEG), the prepolymer of the polycaprolactone diol (PCLDL) and the methylenediphenyl diisocyanate (MDI) connected to the two ends of the polycaprolactone diol (PCLDL), the methylenediphenyl diisocyanate (MDI) monomer and the prepolymer of the polyol C and the methylenediphenyl diisocyanate (MDI) connected to the two ends of the polyol C) was prepared.

### Comparative Example 1

Preparation of Prepolymer D

Under a nitrogen environment, 259 grams of methylenediphenyl diisocyanate (MDI) was added to a reaction tank and heated to 50° C. with stirring for 30 minutes. Next, 500 grams of polycaprolactone diol (PCLDL) (OHV=56, CAPA7201A/Perstorp) was added to react at 60° C. until NCO=8.7%. So far, prepolymer D (including the prepolymer of the polycaprolactone diol (PCLDL) and the methylenediphenyl diisocyanate (MDI) connected to the two ends of the polycaprolactone diol (PCLDL)) was prepared.

### Example 7

Preparation of Polyurethane Elastomer A

First, 100 grams of prepolymer A was defoamed at 70° C. under vacuum until no bubbles were formed. Next, 8.65 grams of a chain extender (1,4-BDO) was added with uniform stirring. Next, the above mixture was filled into respective 2-mm and 11-mm film sets and baked in an oven at 116° C. for 2 hours. Next, the film sets were moved to an oven at 100° C. for 16 hours to complete the preparation of polyurethane elastomer A. The elastomer A was taken out and placed at room temperature for 4 weeks, and relevant physical properties (including hardness, rebound resilience, rigidity (100% modulus, 300% modulus), tensile strength, etc.) were tested. The results are shown in Table 1.

### Example 8

Preparation of Polyurethane Elastomer B

First, 100 grams of prepolymer B was defoamed at 70° C. under vacuum until no bubbles were formed. Next, 8.78 grams of a chain extender (1,4-BDO) was added with uniform stirring. Next, the above mixture was filled into respective 2-mm and 11-mm film sets and baked in an oven at 116° C. for 2 hours. Next, the film sets were moved to an oven at 100° C. for 16 hours to complete the preparation of polyurethane elastomer B. The elastomer B was taken out and placed at room temperature for 4 weeks, and relevant physical properties (including hardness, rebound resilience, rigidity (100% modulus, 300% modulus), tensile strength, etc.) were tested. The results are shown in Table 1.

### Example 9

Preparation of Polyurethane Elastomer C

First, 100 grams of prepolymer C was defoamed at 70° C. under vacuum until no bubbles were formed. Next, 8.79 grams of a chain extender (1,4-BDO) was added with uniform stirring. Next, the above mixture was filled into respective 2-mm and 11-mm film sets and baked in an oven at 116° C. for 2 hours. Next, the film sets were moved to an oven at 100° C. for 16 hours to complete the preparation of polyurethane elastomer C. The elastomer C was taken out and placed at room temperature for 4 weeks, and relevant physical properties (including hardness, rebound resilience, rigidity (100% modulus, 300% modulus), tensile strength, etc.) were tested. The results are shown in Table 1.

### Comparative Example 2

Preparation of Polyurethane Elastomer D

First, 100 grams of prepolymer D was defoamed at 70° C. under vacuum until no bubbles were formed. Next, 8.79 grams of a chain extender (1,4-BDO) was added with uniform stirring. Next, the above mixture was filled into respective 2-mm and 11-mm film sets and baked in an oven at 116° C. for 2 hours. Next, the film sets were moved to an oven at 100° C. for 16 hours to complete the preparation of polyurethane elastomer D. The elastomer D was taken out and placed at room temperature for 4 weeks, and relevant physical properties (including hardness, rebound resilience, rigidity (100% modulus, 300% modulus), tensile strength, etc.) were tested. The results are shown in Table 1.

The hardness (Shore A) was tested according to ASTM D2244. The rebound resilience (%) was tested according to ASTM D2632. 100% modulus and 300% modulus were tested according to ASTM D-412. The tensile strength was tested according to ASTM D-412.

TABLE 1

| PU | Commercially | | | | |
|---|---|---|---|---|---|
| elastomer | available | A | B | C | D |
| Prepolymer | B836 | prepolymer A | prepolymer B | prepolymer C | prepolymer D |
| Chain extender | 1,4-BDO | 1,4-BDO | 1,4-BDO | 1,4-BDO | 1,4-BDO |
| NCO % | 8.79 | 8.5 | 8.63 | 8.64 | 8.64 |
| Weight of | 100 | 100 | 100 | 100 | 100 |
| prepolymer (g) | | | | | |
| Weight of chain | 8.94 | 8.65 | 8.78 | 8.79 | 8.79 |
| extender (g) | | | | | |
| Equivalent ratio of | 100/95 | 100/95 | 100/95 | 100/95 | 100/95 |
| prepolymer/chain extender | | | | | |

Physical properties

| | | | | | |
|---|---|---|---|---|---|
| Hardnesss (A) | 92 | 95 | 91 | 92 | 91 |
| Rebound | 61 | 60 | 62 | 58 | 57 |
| resilience (%) | | | | | |
| 100% modulus (M1) | 97 | 130 | 92 | 98 | 80 |
| (kgf/cm²) | | | | | |
| 300% modulus (M1) | 213 | 263 | 165 | 205 | 134 |
| (kgf/cm²) | | | | | |
| Tensile | 392 | 374 | 293 | 420 | 268 |
| strength (TS) | | | | | |
| (kgf/cm²) | | | | | |

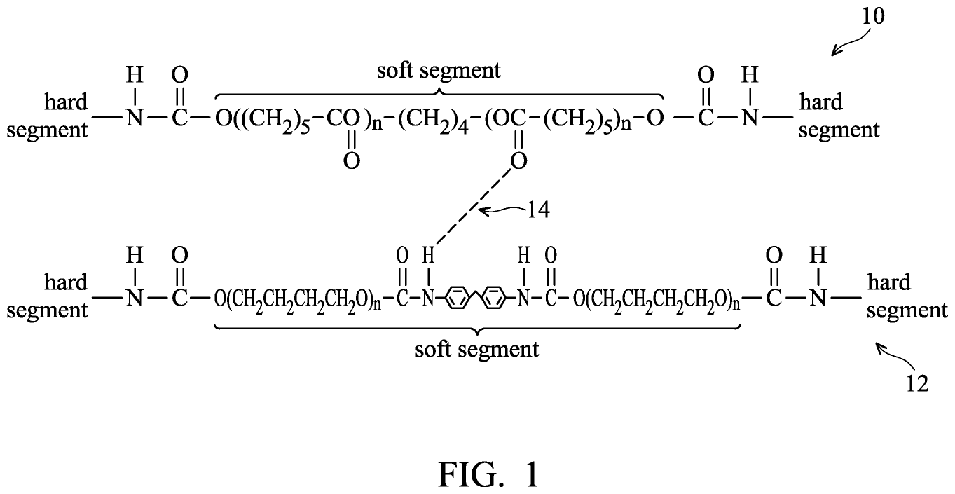

In accordance with the test data in Table 1, also referring to FIG. 1, in PU elastomer A which was prepared from prepolymer A, since a hydrogen bonding 14 (i.e., a sub-crosslinking structure between soft segments) was formed between the C═O bond of the polycaprolactone diol (PCLDL) of the first polymer 10 and the N—H bond of polyol A of the second polymer 12 in the elastomer, the rigidity (100% modulus, 300% modulus) of PU elastomer A was significantly improved compared to the commercially available PU elastomer, and maintained considerable rebound resilience. Conversely, in PU elastomer D which was prepared from prepolymer D, no sub-crosslinking structure between the soft segments was formed in the elastomer, resulting in loose soft-segment structures and poor arrangement, so that the rigidity (100% modulus, 300% modulus) of PU elastomer D was significantly lower than that of the commercially available PU elastomer, and the rebound resilience was also poor.

In the present invention, in order to achieve high rigidity and high elastic recovery simultaneously, the structure of the soft segment is modified to generate a sub-crosslinking structure within the soft segments. The cross-linking strengthens the structure and alignment of the soft domain. Modifications, such as polyfunctionalization, chemical cross-linking, and physical cross-linking (e.g. Van der Waals force), are commonly applied to maintain the arrangement of the soft segments. The present invention applies special molecular modifications in the soft segments to reinforce hydrogen bonds within the soft domains. By cross-linking the soft segments, the PU elastomer shows improved hardness and rigidity, while it still holds the considerable rebound resilience.

While the invention has been described by way of example and in terms of preferred embodiment, it should be understood that the invention is not limited thereto. On the contrary, it is intended to cover various modifications and similar arrangements (as would be apparent to those skilled in the art). Therefore, the scope of the appended claims should be accorded the broadest interpretation so as to encompass all such modifications and similar arrangements.

1. A polyurethane prepolymer composition, comprising:
a first prepolymer comprising a polyol having two ends and diisocyanates, wherein the two ends of the polyol are connected with the diisocyanates;
a second prepolymer comprising a diisocyanate monomer; and
a third prepolymer comprising a first diisocyanate having two ends, polyols and second diisocyanates, wherein the two ends of the first diisocyanate are connected with the polyols, and the other ends of the polyols are connected with the second diisocyanates.

2. The polyurethane prepolymer composition as claimed in claim 1, wherein the polyol comprises polytetramethylene ether glycol (PTMEG), polypropylene glycol (PPG), polyethylene glycol (PEG), polycarbonate diol (PCDL), polycaprolactone diol (PCLDL) or ethylene oxide-propylene oxide (EO-PO) copolymer diol.

3. The polyurethane prepolymer composition as claimed in claim 1, wherein the diisocyanate of the first prepolymer, the diisocyanate monomer of the second prepolymer, and the first diisocyanate and the second diisocyanate of the third prepolymer comprise methylenediphenyl diisocyanate (MDI), hydrogenated 1,4-xylylene diisocyanate (1,4-H6XDI), xylylene diisocyanate (XDI), 1,4-phenylene diisocyanate (PPDI), tolylene diisocyanate (TDI), hexamethylene diisocyanate (HDI), isophorone diisocyanate (IPDI), 4,4′-methylene dicyclohexyl diisocyanate (H12MDI), trimethyl hexamethylene diisocyanate (TMDI), 1,5-naphthalene diisocyanate (NDI) or 3′-dimethylbiphenyl-4,4′-diyl diisocyanate (TODI).

4. The polyurethane prepolymer composition as claimed in claim 1, wherein the third prepolymer has a ratio in the polyurethane prepolymer composition which is in a range from 0% to 65%.

5. The polyurethane prepolymer composition as claimed in claim 1, wherein the third prepolymer has a ratio in the polyurethane prepolymer composition which is in a range from 10% to 20%.

6. A polyurethane elastomer, comprising:
a first polymer comprising a plurality of soft segments and a plurality of hard segments alternately arranged with each other, wherein the soft segment comprises a polyol having two ends, the hard segment comprises a chain extender, a diisocyanate and a diisocyanate monomer, and the soft segment and the hard segment are connected by a urethane bond; and
a second polymer arranged adjacent to the first polymer, the second polymer comprising a plurality of soft segments and a plurality of hard segments alternately arranged with each other, wherein the soft segment comprises a first diisocyanate having two ends and polyols, the hard segment comprises a chain extender, a second diisocyanate and a diisocyanate monomer, and the soft segment and the hard segment are connected by a urethane bond, wherein a hydrogen bond is formed between the soft segment of the first polymer and the soft segment of the second polymer.

7. The polyurethane elastomer as claimed in claim 6, wherein the chain extender comprises diol compounds.

8. The polyurethane elastomer as claimed in claim 7, wherein the chain extender comprises ethylene alcohol (EG), propylene alcohol (PG), 1.4-butylene alcohol (1.4-BDO), 1.3-butylene alcohol (1.3-BDO), 1,6-hexanediol (1,6-HD), diethylene glycol (DEG), 3-methyl-2,5-pentadiol (MPD) or diethylene glycol (DPG).

9. The polyurethane elastomer as claimed in claim 6, wherein the second polymer has a ratio in the polyurethane elastomer which is in a range from 0% to 60%.

10. The polyurethane elastomer as claimed in claim 6, wherein the second polymer has a ratio in the polyurethane elastomer which is in a range from 10% to 20%.

11. A method for preparing a polyurethane elastomer, comprising:
mixing polyols and a diisocyanate having two ends to form a first polyol, wherein the two ends of the diisocyanate are connected with the polyols;
mixing a polyol having two ends, diisocyanates and the first polyol having two ends to form a polyurethane prepolymer composition comprising a first prepolymer, a second prepolymer and a third prepolymer, wherein the first prepolymer comprises the polyol and the diisocyanates connected to the two ends of the polyol, the second prepolymer comprises the diisocyanate, and the third prepolymer comprises the first polyol and the diisocyanates connected to the two ends of the first polyol; and
adding a chain extender to form a polyurethane elastomer, wherein the polyurethane elastomer comprises a first polymer and a second polymer arranged adjacent to the first polymer, the first polymer comprising a plurality of soft segments and a plurality of hard segments alternately arranged with each other, wherein the soft segment comprises the polyol of the first prepolymer, the hard segment comprises the chain extender, the diisocyanate of the first prepolymer and the diisocyanate of the second prepolymer, and the soft segment and the hard segment are connected by a urethane bond, the second polymer comprising a plurality of soft segments and a plurality of hard segments alternately arranged with each other, wherein the soft segment comprises the first polyol of the third prepolymer, the hard segment comprises the chain extender, the diisocyanate of the third prepolymer and the diisocyanate of the second prepolymer, and the soft segment and the hard segment are connected by a urethane bond, wherein a hydrogen bond is formed between the soft segment of the first polymer and the soft segment of the second polymer.

12. The method for preparing a polyurethane elastomer as claimed in claim 11, wherein the polyol comprises polytetramethylene ether glycol (PTMEG), polypropylene glycol (PPG), polyethylene glycol (PEG), polycarbonate diol (PCDL), polycaprolactone diol (PCLDL) or ethylene oxide-propylene oxide (EO-PO) copolymer diol.

13. The method for preparing a polyurethane elastomer as claimed in claim 11, wherein the diisocyanate comprises methylenediphenyl diisocyanate (MDI), hydrogenated 1,4-xylylene diisocyanate (1,4-H6XDI), xylylene diisocyanate (XDI), 1,4-phenylene diisocyanate (PPDI), tolylene diisocyanate (TDI), hexamethylene diisocyanate (HDI), isophorone diisocyanate (IPDI), 4,4′-methylene dicyclohexyl diisocyanate (H12MDI), trimethyl hexamethylene diisocyanate (TMDI), 1,5-naphthalene diisocyanate (NDI) or 3′-dimethylbiphenyl-4,4′-diyl diisocyanate (TODI).

14. The method for preparing a polyurethane elastomer as claimed in claim 11, wherein the chain extender comprises ethylene alcohol (EG), propylene alcohol (PG), 1.4-butylene alcohol (1.4-BDO), 1.3-butylene alcohol (1.3-BDO), 1,6-hexanediol (1,6-HD), diethylene glycol (DEG), 3-methyl-2,5-pentadiol (MPD) or diethylene glycol (DPG).
